(19) United States
(12) Patent Application Publication
(10) Pub. No.: US 2026/0336119 A1
(43) Pub. Date: Oct. 29, 2026

(54) SUB-THRESHOLD ANOMALY PATTERN DETECTION USING COMPOSITE ACOUSTIC SIGNATURES

(71) Applicant: Intel Corporation, Santa Clara, CA (US)

(72) Inventor: Robert Vaughn, Portland, OR (US)

(21) Appl. No.: 19/433,652

(22) Filed: Dec. 26, 2025

(51) Int. Cl. B25J 9/16; G01N 29/14; G01N 29/44

(52) U.S. Cl. CPC B25J 9/1674; B25J 9/1651; B25J 9/1653; G01N 29/14; G01N 29/4463

(57) ABSTRACT

A system includes an acoustic sensor array configured to capture acoustic emissions from a mechanical system during operation of the mechanical system. The system includes a processor configured to generate a system-level composite acoustic signature by combining temporally synchronized acoustic responses from a plurality of sensors of the acoustic sensor array. The processor is configured to compare the system-level composite acoustic signature against context-specific baseline signatures. The processor is configured to detect a sub-threshold anomaly pattern based on the comparison. Detection of the sub-threshold anomaly pattern is performed independently of any individual sensor exceeding its respective alert threshold. The sub-threshold anomaly pattern represents a spatially distributed correlation across the plurality of sensors indicative of an anomalous system-level condition undetectable from any individual sensor in isolation.

### TECHNICAL FIELD

The present disclosure relates to robotic system monitoring and diagnostics, and more particularly to a distributed anomaly detection system that analyzes composite acoustic signatures from robotic manipulators to detect sub-threshold anomaly patterns. As used herein, “sub-threshold” refers to conditions in which individual sensors, or groups of individual sensors such as sensor fusion arrangements, report readings within their respective acceptable operating ranges, yet collective acoustic patterns indicate system degradation requiring intervention.

### BACKGROUND

Robotic manipulators are employed across numerous industrial applications, including manufacturing, assembly, material handling, and precision operations. These systems typically incorporate multiple sensors to monitor operational parameters and detect potential failures or degradation.

Conventional monitoring approaches for robotic systems include force/torque sensors at joints, accelerometers for vibration analysis, strain gauges for localized deformation measurement, and joint encoders for position tracking. These sensors generally operate by comparing measured values against predetermined thresholds to trigger alerts when readings exceed acceptable limits. Sensor fusion techniques combine data from multiple sensors to improve detection capabilities, though such approaches still rely on threshold-based triggering mechanisms.

Acoustic monitoring techniques have been applied in structural health monitoring contexts. Some approaches use active signal injection, in which controlled acoustic signals are transmitted through a structure and changes in propagation characteristics are analyzed to detect degradation. Other approaches monitor ambient acoustic emissions generated during system operation.

Robotic manipulators present particular challenges for monitoring systems due to their articulated structures, dynamic motion profiles, and varying operational contexts. Different tasks, loads, environmental conditions, and joint configurations can produce different baseline operational characteristics. Additionally, certain types of mechanical degradation may develop gradually and manifest as subtle changes that do not trigger individual sensor thresholds.

Referring to FIG. 1, a conventional robotic arm 100 is illustrated with acoustic monitoring components. The robotic arm 100 is equipped with an acoustic wave generator 110 comprising piezoelectric actuators to inject controlled frequency excitation signals into the robotic structure. An acoustic sensor array 120 is integrated along the robotic arm 100 to detect acoustic wave propagation and capture acoustic emissions. This configuration enables actively generated acoustic signals or ambient acoustic signals for structural health assessment.

### BRIEF DESCRIPTION OF THE FIGURES

Non-limiting and non-exhaustive examples are described with reference to the following figures.

FIG. 1 illustrates a robotic arm configured with acoustic monitoring components.

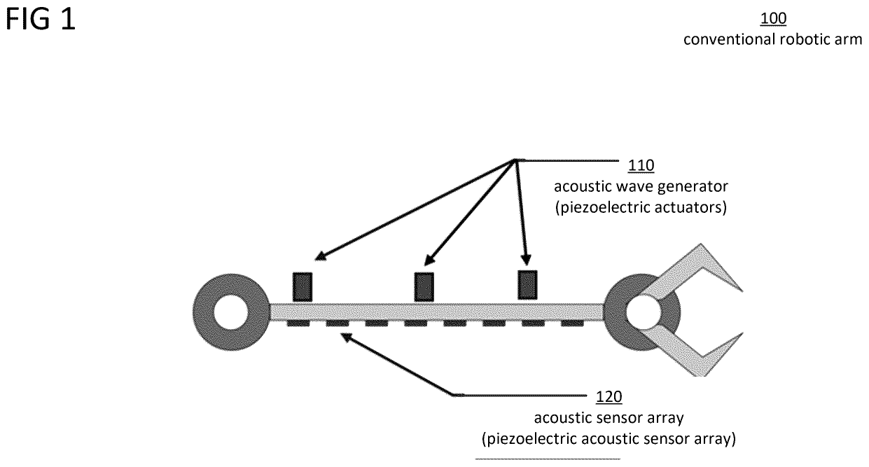

FIG. 2 illustrates a block diagram of a distributed anomaly detection system integrated with a robotic system, according to aspects of the present disclosure.

FIG. 3 illustrates a sequence diagram representing the distributed anomaly detection system of FIG. 2, according to aspects of the present disclosure.

FIG. 4 illustrates a block diagram of a compute device, according to aspects of the present disclosure.

### DETAILED DESCRIPTION

The following description sets forth exemplary aspects of the present disclosure. It should be recognized, however, that such a description is not intended as a limitation on the scope of the present disclosure. Rather, the description also encompasses combinations and modifications to those exemplary aspects described herein.

The present disclosure relates to distributed anomaly detection systems for mechanical systems, including robotic manipulators. Mechanical systems, such as robotic manipulators, may include various sensors configured to monitor operational parameters during operation. Conventional monitoring approaches may rely on individual sensor thresholds to detect anomalous conditions, generating an alert when a single sensor reading exceeds a predetermined threshold. In some cases, conventional approaches may employ sensor fusion techniques that combine readings from multiple sensors and compare the fused result against a threshold.

A technical challenge arises when system degradation occurs in a manner that does not cause any individual sensor to exceed its respective alert threshold. In such cases, each sensor may report readings within normal operating ranges, yet the mechanical system may exhibit degradation that affects overall system performance or reliability. For example, progressive wear, fatigue accumulation, or stress concentration may develop across multiple components of a mechanical system without triggering any single sensor alert. Conventional threshold-based monitoring approaches may fail to detect such conditions because the monitoring logic depends on at least one sensor exceeding its designated threshold.

The present disclosure addresses this technical challenge by using system-level composite acoustic signatures. An acoustic sensor array may capture acoustic emissions from a mechanical system during its operation. A processor may generate a system-level composite acoustic signature by combining temporally synchronized acoustic responses from a plurality of sensors in the acoustic sensor array. The system-level composite acoustic signature may represent a holistic characterization of acoustic behavior across the mechanical system rather than isolated measurements from individual sensor locations.

Detection of anomalous conditions may be performed by comparing the system-level composite acoustic signature against context-specific baseline signatures. The context-specific baseline signatures may correspond to distinct operational states of the mechanical system, such as different task profiles, configuration states, motion states, or environmental conditions. By comparing current composite signatures against baseline signatures established for matching operational contexts, the system may identify deviations that indicate system-level anomalies.

A sub-threshold anomaly pattern may be detected by comparing the system-level composite acoustic signature with context-specific baseline signatures. Detection of the sub-threshold anomaly pattern may be performed independently of any individual sensor exceeding its respective alert threshold. The sub-threshold anomaly pattern may represent a spatially distributed correlation across the plurality of sensors indicative of an anomalous system-level condition undetectable from any individual sensor in isolation. In some cases, individual sensors may each report readings ranging from 50% to 90% of their respective alert thresholds, yet the collective pattern across the sensor array may indicate an anomalous condition when analyzed as a composite signature.

The system-level composite acoustic signature may comprise various acoustic characteristics, including frequency shifts, amplitude changes, or wave velocity changes. These characteristics may reflect changes in structural properties, material conditions, or mechanical coupling within the mechanical system. Temperature compensation may be applied to the system-level composite acoustic signature to account for thermal effects on acoustic propagation properties.

The anomalous system-level condition detected via sub-threshold anomaly patterns may result from structural degradation, material fatigue, or stress concentration. Such conditions may develop progressively over time and may affect multiple locations or components within the mechanical system simultaneously. The spatially distributed nature of these conditions may produce correlated changes across multiple sensors, detectable through composite signature analysis even when no individual sensor reading exceeds its threshold.

In some implementations, an adaptive behavior controller may be configured to proactively adjust the mechanical system's operational parameters to mitigate the progression of the detected sub-threshold anomaly pattern. The operational parameters may comprise velocity, acceleration, or trajectory. By adjusting these parameters in response to detected anomaly patterns, the system may reduce stress on affected components and extend the mechanical system's operational life.

A baseline signature database may store the context-specific baseline signatures used for comparison. The baseline signature database may be updated using composite acoustic signatures classified as nominal for a corresponding operational context. This updating mechanism may enable the system to adapt to changes in the mechanical system over time, such as component replacement or environmental changes, while maintaining accurate baseline references for anomaly detection.

A predictive maintenance alert may be generated based on the sub-threshold anomaly pattern. The predictive maintenance alert may indicate that maintenance attention is warranted even though no individual sensor has exceeded its alert threshold. This approach may enable maintenance to be scheduled before degradation progresses to a level that would trigger conventional threshold-based alerts or cause operational failures.

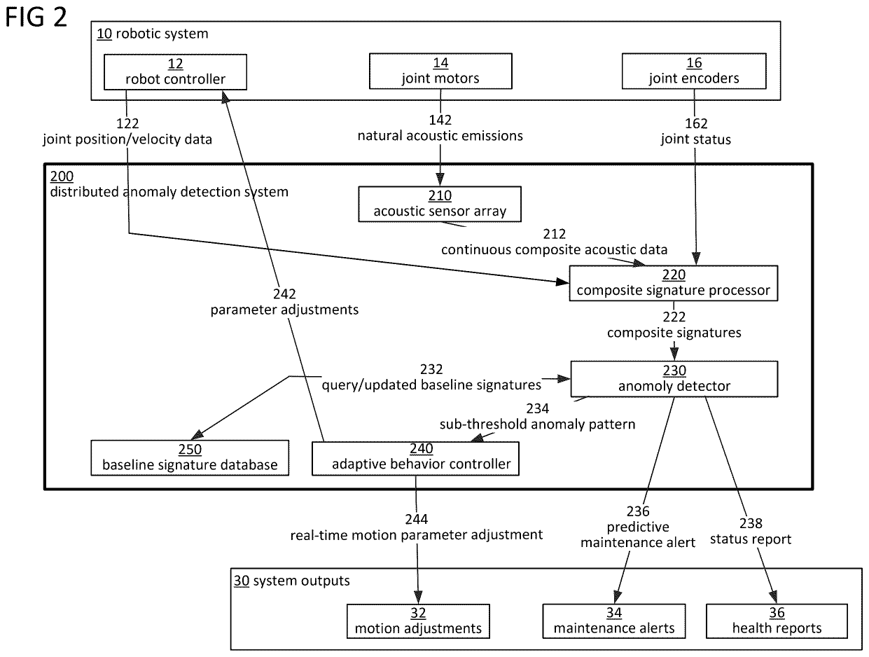

Referring to FIG. 2, a block diagram illustrates a distributed anomaly detection system 200 integrated with a robotic system 10. The robotic system 10 includes a robot controller 12, joint motors 14, and joint encoders 16. The robot controller 12 provides position/velocity data 122 to the distributed anomaly detection system 200. The position/velocity data 122 may be sampled at standard robot control frequencies of 100-1000 Hz. The joint motors 14 produce natural acoustic emissions 142 during operation of the robotic system 10. The joint encoders 16 provide joint status 162 to the distributed anomaly detection system 200.

With continued reference to FIG. 2, the distributed anomaly detection system 200 includes an acoustic sensor array 210. The acoustic sensor array 210 captures the natural acoustic emissions 142 from the joint motors 14. The acoustic sensor array 210 captures holistic audio from an entire robotic structure rather than monitoring individual joints separately. This configuration enables the detection of naturally mixed acoustic emissions throughout an articulated robotic structure. The acoustic sensor array 210 may sample acoustic data at frequencies between 1-10 kHz, depending on the arm dynamics of the robotic system 10.

As further shown in FIG. 2, the distributed anomaly detection system 200 passively listens to ambient operational sound during normal robot operation rather than requiring injection of test signals. The natural acoustic emissions 142 produced by the joint motors 14 during standard operational tasks provide acoustic information that the acoustic sensor array 210 captures without active acoustic interrogation. The acoustic sensor array 210 generates continuous composite acoustic data 212 from captured natural acoustic emissions 142. The composite acoustic data 212 represents a holistic characterization of acoustic behavior across the robotic system 10 derived from the naturally mixed acoustic emissions throughout the articulated robotic structure.

The composite acoustic data 212 is transmitted to a composite signature processor 220. The composite signature processor 220 receives the continuous composite acoustic data 212 from the acoustic sensor array 210 and also receives the position/velocity data 122 from the robot controller 12. The composite signature processor 220 generates system-level composite signatures 222 by combining temporally-synchronized acoustic responses from the plurality of sensors in the acoustic sensor array 210. The temporal synchronization aligns acoustic measurements captured across the distributed sensor array to a common time reference, enabling correlation of acoustic events occurring at different spatial locations within the robotic system 10.

The composite signature processor 220 compensates for Doppler effects during dynamic robotic motion when analyzing acoustic signatures. As segments of the robotic system 10 move relative to sensors of the acoustic sensor array 210, relative motion between acoustic sources and sensors may introduce frequency shifts in the captured acoustic emissions. The composite signature processor 220 uses the position/velocity data 122 received from the robot controller 12 to calculate expected Doppler shifts based on current joint velocities and sensor positions. The composite signature processor 220 applies compensation factors to the composite acoustic data 212 to remove motion-induced frequency distortions from the composite signatures 222.

The distributed anomaly detection system 200 includes temperature sensors embedded in manipulator segments and joints for acoustic velocity compensation. The temperature sensors may comprise thermocouples or resistance temperature detectors (RTDs) located along the robotic arm structure. Acoustic wave propagation velocity through structural materials varies with temperature, and uncompensated temperature variations may introduce errors in acoustic signature analysis. Environmental temperature data may be sampled at 1-10-second intervals via the embedded thermocouples. The composite signature processor 220 applies temperature compensation to the composite acoustic data 212 using the sampled temperature measurements to correct for thermal effects on acoustic propagation properties.

The composite signature processor 220 performs acoustic propagation modeling specific to articulated robotic structures with multiple joints and varying mechanical coupling between segments. Articulated robotic structures present acoustic propagation characteristics that differ from continuous structural members due to the presence of joints connecting adjacent segments. Mechanical coupling between segments may vary based on joint type, joint configuration, and loading conditions. The acoustic propagation modeling accounts for acoustic transmission, reflection, and attenuation at joint interfaces between segments. The composite signature processor 220 uses the joint status 162 received from the joint encoders 16 to determine current joint configurations and applies corresponding acoustic propagation models when generating the composite signatures 222. This modeling enables the composite signature processor 220 to distinguish acoustic signature variations caused by changes in joint configuration from variations indicative of anomalous conditions within the robotic system 10.

The distributed anomaly detection system 200 includes a baseline signature database 250 configured to store context-specific baseline signatures 232. The baseline signature database 250 stores baseline signatures 232 corresponding to distinct operational states of the robotic system 10, rather than maintaining a single global normal baseline. The context-specific baseline signatures 232 may correspond to different task types, including pick-and-place operations, assembly operations, or welding operations. The baseline signature database 250 may also store baseline signatures 232 corresponding to different environmental conditions, different load parameters, and different pose or orientation configurations of the robotic system 10.

The distributed anomaly detection system 200 includes an anomaly detector 230 configured to compare the composite signatures 222 against the baseline signatures 232. The anomaly detector 230 queries the baseline signature database 250 for baseline signatures 232 that match a current operational context of the robotic system 10. The current operational context may include the current task type being performed, current environmental conditions, current load parameters such as weight or volume of objects being manipulated, and current pose or orientation of the robotic system 10. The anomaly detector 230 receives the baseline signatures 232 from the baseline signature database 250 and compares the composite signatures 222 generated by the composite signature processor 220 against the retrieved baseline signatures 232.

The baseline signature database 250 may store baseline signatures 232 for specific combinations of operational parameters. For example, a pick-and-place operation involving a twenty-pound load may have an associated baseline signature 232 that differs from a baseline signature 232 associated with a pick-and-place operation involving a five-pound load. Similarly, the baseline signature database 250 may store different baseline signatures 232 for the same task type performed at different ambient temperatures or in different environmental noise conditions. This context-specific storage enables the anomaly detector 230 to compare current composite signatures 222 against baseline signatures 232 established under matching operational conditions.

The distributed anomaly detection system 200 uses pattern recognition algorithms to establish and update the baseline signatures 232 stored in the baseline signature database 250. The pattern recognition algorithms correlate acoustic patterns with robotic operational states, including normal operation, degraded performance, and maintenance required conditions. The pattern recognition algorithms continuously update the baseline signature database 250 by incorporating new acoustic data with corresponding operational outcomes. When the robotic system 10 operates under a particular operational context, and the composite signatures 222 are classified as nominal for that context, the pattern recognition algorithms may update the corresponding baseline signatures 232 in the baseline signature database 250.

The baseline signature database 250 may be populated through supervised learning built from repeated operational cycles of the robotic system 10. The robotic system 10 may perform hundreds or thousands of repeated operational cycles during which the acoustic sensor array 210 captures the natural acoustic emissions 142, and the composite signature processor 220 generates the composite signatures 222. Each operational cycle may be labeled with corresponding operational parameters, including task type, load parameters, environmental conditions, and pose or orientation. The labeled data from the repeated operational cycles provides training data for the pattern recognition algorithms to establish baseline signatures 232 for each combination of operational parameters. As the robotic system 10 accumulates additional operational cycles, the pattern recognition algorithms may refine the baseline signatures 232 stored in the baseline signature database 250 to improve detection sensitivity and reduce false positive detections.

The anomaly detector 230 detects a sub-threshold anomaly pattern 234 based on comparison between the composite signatures 222 and the baseline signatures 232. The sub-threshold anomaly pattern 234 may be detected when individual sensors of the acoustic sensor array 210 exhibit readings at levels typically between 50% and 90% of their respective alert thresholds. At these reading levels, no individual sensor, or group of individual sensors (e.g., sensor fusion), exceeds its designated alert threshold, and conventional threshold-based monitoring approaches would not generate an alert. However, the collective pattern of readings across the plurality of sensors of the acoustic sensor array 210 may indicate system degradation when analyzed as a composite signature by the anomaly detector 230.

The sub-threshold anomaly pattern 234 represents a spatially distributed correlation across the plurality of sensors of the acoustic sensor array 210. The spatially distributed correlation may manifest as coordinated deviations from baseline acoustic characteristics at multiple sensor locations within the robotic system 10. For example, sensors positioned at different locations along the robotic arm 100 may each report acoustic amplitude changes at 65%, 70%, and 60% of their respective alert thresholds. While each individual reading falls within normal operating ranges, the correlated pattern of deviations across the spatially distributed sensors may indicate an anomalous system-level condition. The anomaly detector 230 analyzes the composite signatures 222 to identify such spatially distributed correlations that would be undetectable from any individual sensor in isolation.

The anomalous system-level condition indicated by the sub-threshold anomaly pattern 234 may encompass conditions affecting multiple components or locations within the robotic system 10 simultaneously. Progressive wear, fatigue accumulation, or stress concentration may develop across the robotic arm 100, producing correlated acoustic signature changes at multiple sensor locations. The anomaly detector 230 may detect these conditions by analyzing the composite signatures 222 before any individual sensor reading reaches its alert threshold.

The distributed anomaly detection system 200 may detect unexpected rotational and constraint forces during complex object manipulation that conventional joint-mounted force/torque sensors cannot detect. Conventional force/torque sensors mounted at the joints of the robotic system 10 measure net forces at joint locations but cannot distinguish between planned articulation loads, expected object interaction forces, and unexpected constraint forces arising from binding, interference, or variations in object properties. The acoustic sensor array 210 captures the natural acoustic emissions 142 produced throughout the robotic arm 100 during manipulation tasks, and the composite signature processor 220 generates the composite signatures 222 that reflect acoustic characteristics associated with rotational and constraint forces distributed across arm segments.

The distributed anomaly detection system 200 may detect torsional stress concentrations in arm segments of the robotic arm 100. Torsional stress concentrations may arise when the robotic system 10 encounters unexpected resistance during rotation or when manipulated objects bind against environmental constraints. The torsional stress concentrations produce acoustic emissions that propagate through the robotic arm 100 and are captured by the acoustic sensor array 210. The composite signature processor 220 generates composite signatures 222 that reflect the acoustic characteristics associated with torsional stress concentrations. The anomaly detector 230 compares the composite signatures 222 against the baseline signatures 232 to detect deviations indicative of torsional stress concentrations.

The distributed anomaly detection system 200 may detect localized loading in arm segments before the associated forces propagate to the joint sensors of the robotic system 10. Localized loading may occur when external forces are applied to arm segments at locations between joints, or when internal stress distributions within arm segments deviate from expected patterns. The acoustic sensor array 210 captures the natural acoustic emissions 142 associated with the localized loading at the loading location. The composite signature processor 220 generates the composite signatures 222 that reflect the acoustic characteristics of the localized loading. The anomaly detector 230 may detect the sub-threshold anomaly pattern 234 associated with the localized loading before the forces propagate through the arm structure to joint-mounted sensors. This detection capability enables identification of loading conditions that conventional joint-mounted force/torque sensors would not detect until the forces reach a sufficient magnitude to affect joint-level measurements.

The anomaly detector may use an Acoustic Health Index (AHI) formula to quantify deviations between current acoustic characteristics and baseline acoustic characteristics. The AHI formula combines three acoustic indicators, each weighted by its sensitivity to structural changes within the mechanical system. The AHI formula may be expressed as:

$$AHI = 100 \times \frac{\vert {f}_{c} - {f}_{b} \vert}{{f}_{b}} + 50 \times \frac{\vert {A}_{c} - {A}_{b} \vert}{{A}_{b}} + 25 \times \frac{\vert {v}_{c} - {v}_{b} \vert}{{v}_{b}} ,$$

where fc represents a current resonant frequency, fb represents a baseline resonant frequency, Ac represents a current signal amplitude, Ab represents a baseline signal amplitude, vc represents a current wave velocity, and vb represents a baseline wave velocity.

The frequency-shift component of the AHI formula receives a weighting factor of 100, reflecting that frequency shift may be highly sensitive to stiffness loss within structural members. Changes in resonant frequency may indicate alterations in material stiffness properties that occur during progressive structural degradation. The frequency-shift component may also detect degradation within articulated joints of the mechanical system. Robotic joints may include bearing sets, bushings, or other rotational components that provide angular or rotational capabilities between segments. A failing bearing set may be conventionally observed through angular deviation at the joint, yet such observation may occur only after significant degradation has developed. The system-level composite acoustic signature may identify anomalous acoustic emissions related to increased bearing friction, bearing slap, or other acoustic characteristics associated with bearing wear before angular deviation becomes detectable through conventional sensors. Acoustic emissions from degrading bearings may propagate across and through other parts of the robotic system, enabling detection by the distributed acoustic sensor array even when the degradation occurs at locations remote from individual sensors. The amplitude change component receives a weighting factor of 50, reflecting that amplitude changes may indicate damping variations or crack formation within the mechanical system. The wave velocity change component receives a weighting factor of 25, reflecting that wave velocity changes may indicate bulk material property degradation. The relative weighting of these three components enables the AHI formula to produce a composite metric that reflects the contributions of multiple acoustic characteristics, each weighted by its diagnostic value for detecting structural changes.

Temperature compensation may be applied to measured wave velocities before calculating the AHI. Acoustic wave propagation velocity through structural materials varies with temperature, and uncompensated temperature variations may introduce errors in the wave velocity component of the AHI calculation. A temperature-compensation formula may be applied to correct measured wave-velocity values for thermal effects. The temperature compensation formula may be expressed as:

v_{comp}=vₘ×(1−0.0017×(T_{c}−Tᵣ)),

where vcomp represents a compensated wave velocity, vm represents a measured wave velocity, Tc represents a current temperature, and Tr represents a reference temperature. The coefficient 0.0017 represents a thermal correction factor that accounts for temperature-dependent changes in acoustic propagation velocity through structural materials. The temperature-compensation formula adjusts the measured wave velocity to a value corresponding to the reference temperature, enabling consistent comparison with baseline wave velocity values established at that temperature.

The anomaly detector 230 may categorize material fatigue risk based on the calculated AHI value. When the AHI exceeds a value of 10, the anomaly detector may categorize the material fatigue risk as HIGH, indicating that cumulative acoustic degradation indicators warrant immediate maintenance attention. When the AHI exceeds a value of 5 but does not exceed 10, the anomaly detector may categorize the material fatigue risk as MEDIUM, indicating that acoustic degradation indicators warrant monitoring and scheduled maintenance consideration. When the AHI does not exceed a value of 5, the anomaly detector may categorize the material fatigue risk as LOW, indicating that acoustic characteristics remain within acceptable deviation ranges from baseline values. The threshold values of 5 and 10, which are examples and not meant to be limiting, provide actionable maintenance thresholds based on cumulative acoustic degradation indicators reflected in the AHI calculation.

The anomaly detector 230 distinguishes between accountable anomalies and unaccountable anomalies when analyzing detected deviations from baseline acoustic signatures. Accountable anomalies comprise acoustic signature changes that can be explained by known context changes occurring during operation of the mechanical system. Unaccountable anomalies comprise acoustic signature changes that cannot be attributed to any known context change and may indicate system degradation requiring maintenance action.

The distributed anomaly detection system 200 may receive sensor data from additional sensors configured to detect external disturbances and context changes during operation. The additional sensors may comprise proximity sensors, cameras, force sensors, or combinations thereof. Proximity sensors may detect when objects or personnel approach the mechanical system during operation. Cameras may capture visual information regarding the operational environment surrounding the mechanical system. Force sensors may detect contact events, such as collisions or impacts, applied to the mechanical system by external sources.

When the anomaly detector 230 detects a deviation in the composite acoustic signature 212 from the baseline acoustic signature 232, the anomaly detector 230 may query the additional sensors to determine whether a known context change occurred contemporaneously with the detected deviation. For example, when a cart bumps into the mechanical system during operation, force sensors may detect the impact, and proximity sensors may detect the cart's presence near the mechanical system. The anomaly detector 230 may correlate the timing of the detected acoustic deviation with the timing of the detected impact event. When the acoustic deviation temporally correlates with the detected impact event, the anomaly detector 230 may classify it as an accountable anomaly attributable to the cart bump rather than an unaccountable anomaly indicative of system degradation.

Similarly, when personnel approach the mechanical system during operation, proximity sensors or cameras may detect their presence in the operational environment. Environmental changes caused by nearby personnel, such as acoustic reflections or vibrations transmitted through floor structures, may produce detectable changes in the composite acoustic signature 222. The anomaly detector 230 may correlate detected acoustic deviations with detected personnel presence to classify them as accountable rather than unaccountable anomalies.

Load changes during operation may also produce accountable acoustic deviations. When the mechanical system lifts or manipulates objects of different weights or volumes, the composite acoustic signature 212 may change in response to the altered loading conditions. The anomaly detector 230 may receive load parameter data indicating current load weight or volume, and may correlate detected acoustic deviations with changes in load parameters. When acoustic deviations correlate with load changes, the anomaly detector 230 may classify the deviations as accountable anomalies attributable to the load change.

Unaccountable anomalies comprise acoustic signature deviations that cannot be explained by any detected context change. When the anomaly detector 230 detects an acoustic deviation and queries the additional sensors without identifying a corresponding context change, it may classify the deviation as an unaccountable anomaly. Unaccountable anomalies may indicate system degradation, component wear, or other conditions requiring maintenance attention. The anomaly detector 230 may generate a predictive maintenance alert upon detecting an unaccountable anomaly.

The baseline signature database 250 may be updated when acoustic changes are determined to be legitimate rather than indicative of faults. Legitimate acoustic changes may result from new environmental conditions or replaced parts within the mechanical system. When a mechanical system component is replaced during maintenance, the replacement component may exhibit acoustic characteristics that differ from those of the original component. The composite acoustic signature captured after component replacement may deviate from baseline signatures established prior to the replacement. Rather than classifying such deviations as anomalies, the system may update the baseline signature database 250 to incorporate the acoustic characteristics of the replacement component.

When environmental conditions change in ways that affect acoustic propagation or acoustic emissions, the baseline signature database 250 may be updated to reflect the new conditions. For example, when the mechanical system is relocated to a different operational environment, ambient acoustic characteristics may differ from the original environment. The system may establish new baseline signatures corresponding to the new environmental conditions and store them in the baseline signature database 250.

The baseline signature database 250 may be updated in response to operator input indicating a legitimate change. An operator may indicate that a component has been replaced or that environmental conditions have changed, and the system may initiate a baseline update procedure in response. During the baseline update procedure, the system may capture composite acoustic signatures during operation under the new conditions and store them as updated baseline signatures in the baseline signature database 250.

In some cases, the system may automatically detect legitimate changes and update the baseline signature database 250 without operator input. When the anomaly detector 230 classifies an acoustic deviation as an accountable anomaly attributable to a known context change, and the context change represents a persistent change in operational conditions, the system may update the baseline signature database 250 to incorporate the acoustic characteristics associated with the new operational conditions. This automatic updating enables the system to adapt to changes in the mechanical system or operational environment while maintaining accurate baseline references for anomaly detection.

The distributed anomaly detection system 200 includes an adaptive behavior controller 240 configured to receive the sub-threshold anomaly pattern 234 from the anomaly detector 230. The adaptive behavior controller 240 generates parameter adjustments 242 based on the received sub-threshold anomaly pattern 234. The parameter adjustments 242 may comprise modifications to operational parameters of the robotic system 10, including velocity, acceleration, or trajectory. The adaptive behavior controller 240 proactively adjusts operational parameters to mitigate the progression of the detected sub-threshold anomaly pattern 234 before it develops into a condition that would trigger conventional threshold-based alerts.

The adaptive behavior controller 240 generates a real-time motion parameter adjustment 244 that modifies the operational behavior of the robotic system 10 during the continued execution of a task. The real-time motion parameter adjustment 244 may reduce the velocity or acceleration of the robotic system 10 when the composite signatures 222 indicate degradation within the robotic arm 100. By reducing velocity or acceleration in response to detected anomaly patterns, the adaptive behavior controller 240 may reduce mechanical stress on affected components and slow the progression of degradation conditions indicated by the sub-threshold anomaly pattern 234.

The adaptive behavior controller 240 performs trajectory optimization to avoid motion patterns that accelerate wear when acoustic anomalies are detected. The trajectory optimization modifies planned motion paths of the robotic system 10 to reduce stress on components exhibiting acoustic signature deviations from the baseline signatures 232. When the anomaly detector 230 detects the sub-threshold anomaly pattern 234 associated with a particular joint or arm segment, the adaptive behavior controller 240 may modify trajectories to reduce loading on the affected joint or segment. The trajectory optimization may select alternative motion paths that accomplish the same task while distributing mechanical loads differently across the joints and segments of the robotic arm 100.

The adaptive behavior controller 240 redistributes load across the joints of the robotic system 10 when localized acoustic anomalies are detected. When the sub-threshold anomaly pattern 234 indicates a localized anomaly affecting a particular joint or segment of the robotic arm 100, the adaptive behavior controller 240 may redistribute load across other joints to reduce stress on the affected joint or segment. The load redistribution may involve modifying joint configurations or motion sequences to shift mechanical loading from the affected joint to other joints of the robotic system 10. This load redistribution may extend the operational life of the affected component by reducing stress accumulation at the location exhibiting the localized acoustic anomaly.

The distributed anomaly detection system 200 enables identification of when structures of the robotic arm 100 are over-engineered and could safely operate with less reinforcement based on actual loading conditions. Conventional robotic manipulator design may employ conservative over-engineering to ensure deterministic behavior with minimal flex, wobble, or vibration. This conservative approach may result in higher energy costs due to mass inertia and increased structural mass. The distributed anomaly detection system 200 provides real-time assessment of the actual loading conditions experienced by the robotic arm 100 during operation by analyzing the composite signatures 222.

When the composite signatures 222 indicate that structural members of the robotic arm 100 experience loading conditions below design assumptions, the distributed anomaly detection system 200 may generate data indicating that reinforcement materials could be safely reduced in future design iterations. The baseline signature database 250 may accumulate acoustic signature data correlated with actual loading conditions over extended operational periods. Analysis of accumulated data may reveal that certain structural members consistently exhibit acoustic signatures indicating stress levels below design thresholds. This information may inform material optimization decisions for future robotic manipulator designs by identifying components where structural reinforcement exceeds requirements for actual operational loading conditions.

Conversely, when the composite signatures 222 indicate that structural members experience loading conditions approaching or exceeding design assumptions, the distributed anomaly detection system 200 may generate data indicating that additional reinforcement may be warranted. The adaptive behavior controller 240 may adjust operational parameters to reduce loading on structural members exhibiting acoustic signatures indicative of elevated stress conditions. The accumulated acoustic signature data may inform design decisions regarding where additional reinforcement may improve reliability or extend the operational life of the robotic arm 100.

The distributed anomaly detection system 200 generates system outputs 30 that provide actionable information for operational control and maintenance planning. The system outputs 30 include motion adjustments 32, maintenance alerts 34, and health reports 36. Each of the system outputs 30 derives from corresponding outputs generated by components of the distributed anomaly detection system 200 during analysis of the composite signatures 222.

The motion adjustments 32 receive input from the real-time motion parameter adjustment 244 generated by the adaptive behavior controller 240. The motion adjustments 32 comprise modifications to the operational parameters of the robotic system 10, transmitted to the robot controller 12 for implementation during continued operation. The motion adjustments 32 may include velocity reductions, acceleration limits, or trajectory modifications determined by the adaptive behavior controller 240 in response to the sub-threshold anomaly pattern 234. The robot controller 12 may implement the motion adjustments 32 by modifying control signals transmitted to the joint motors 14, thereby altering the operational behavior of the robotic arm 100 in accordance with the parameter adjustments 242.

The maintenance alerts 34 receive input from a predictive maintenance alert 236 generated by the anomaly detector 230. The predictive maintenance alert 236 is generated based on the sub-threshold anomaly pattern 234, detected by comparing the composite signatures 222 against the baseline signatures 232. The predictive maintenance alert 236 indicates that maintenance attention may be warranted even though no individual sensor of the acoustic sensor array 210 has exceeded its respective alert threshold. The maintenance alerts 34 transmit the predictive maintenance alert 236 to external monitoring systems, maintenance scheduling systems, or operator interfaces for review and action.

The health reports 36 receive input from a status report 238 generated by the anomaly detector 230. The status report 238 provides information regarding the current acoustic health status of the robotic system 10 based on analysis of the composite signatures 222. The status report 238 may include the calculated Acoustic Health Index value, material fatigue risk categorization, and identification of specific locations or components exhibiting acoustic signature deviations from the baseline signatures 232. The health reports 36 transmit the status report 238 to dashboard interfaces, monitoring systems, or data logging systems for operational visibility and historical tracking.

The distributed anomaly detection system 200 integrates predictive maintenance scheduling with robotic task planning based on acoustic health indicators derived from the composite signatures 222. The predictive maintenance alert 236 may include information regarding the severity of detected anomaly patterns, the estimated time until maintenance may be required, and the identification of affected components or locations within the robotic arm 100. Maintenance scheduling systems may receive the predictive maintenance alert 236 through the maintenance alerts 34 and incorporate the maintenance information into scheduling algorithms that coordinate maintenance activities with production schedules.

The integration of predictive maintenance scheduling with robotic task planning enables coordination between operational demands and maintenance requirements. When the anomaly detector 230 generates the predictive maintenance alert 236 indicating that maintenance may be warranted within a specified time period, task planning systems may adjust task assignments to reduce loading on the affected robotic system 10 or schedule maintenance during planned production breaks. The predictive maintenance alert 236 may include urgency indicators that inform task-planning decisions on whether immediate operational modifications are warranted or whether maintenance may be deferred to a scheduled maintenance window.

The predictive maintenance alert 236 is generated based on analysis of the sub-threshold anomaly pattern 234 in conjunction with historical degradation patterns stored in the baseline signature database 250. The anomaly detector 230 may compare current acoustic signature deviations against historical patterns of degradation progression to estimate remaining operational life before maintenance intervention may be required. The predictive maintenance alert 236 may include confidence levels for maintenance timing estimates derived from the correlation between current acoustic signatures and historical degradation trajectories.

The distributed anomaly detection system 200 may generate the predictive maintenance alert 236 at different urgency levels based on characteristics of the sub-threshold anomaly pattern 234. When the sub-threshold anomaly pattern 234 indicates gradual degradation with a slow progression rate, the predictive maintenance alert 236 may indicate that maintenance may be scheduled during a future maintenance window. When the sub-threshold anomaly pattern 234 indicates accelerating degradation or acoustic signatures approaching threshold levels, the predictive maintenance alert 236 may indicate that maintenance attention is warranted sooner. The urgency levels associated with the predictive maintenance alert 236 enable maintenance scheduling systems to prioritize maintenance activities across multiple robotic systems based on the relative urgency of detected anomaly patterns.

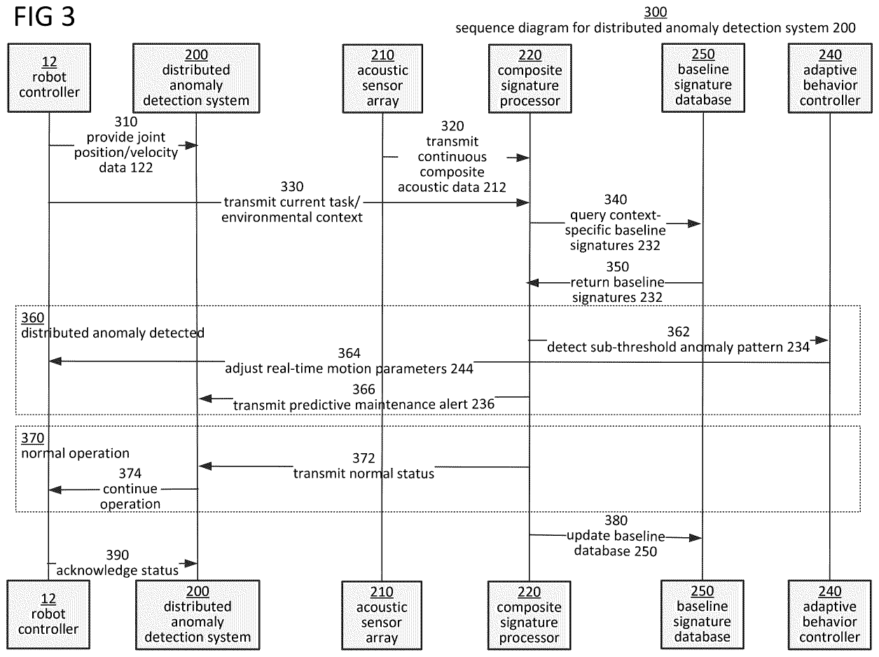

Referring to FIG. 3, a sequence diagram 300 represents the operation of the distributed anomaly detection system 200 for robotic manipulators. The sequence diagram 300 depicts interactions between the robot controller 12, the distributed anomaly detection system 200, the acoustic sensor array 210, the composite signature processor 220, the baseline signature database 250, and the adaptive behavior controller 240. The sequence diagram 300 illustrates a continuous monitoring loop that enables detection of distributed anomalies while allowing the distributed anomaly detection system 200 to adapt the baseline signatures 232 based on operational experience.

With continued reference to FIG. 3, the sequence diagram 300 begins with a provide joint position/velocity data step 310, in which the robot controller 12 transmits joint position and velocity information to the distributed anomaly detection system 200. The joint position/velocity data step 310 establishes a continuous data flow from the robot controller 12 that provides the position/velocity data 122 used for synchronization with acoustic measurements. The joint position and velocity information transmitted during the provide joint position/velocity data step 310 enables the composite signature processor 220 to correlate acoustic events with specific robotic configurations and motion states. The joint position/velocity data step 310 may occur continuously during operation of the robotic system 10, providing real-time position and velocity updates that enable temporal synchronization between acoustic data and robotic motion data.

As further shown in FIG. 3, during a transmit continuous composite acoustic data step 320, the acoustic sensor array 210 sends the composite acoustic data 212 to the composite signature processor 220. The transmit continuous composite acoustic data step 320 represents continuous transmission of acoustic emissions captured from throughout the robotic structure during operation. The composite acoustic data 212 transmitted during the transmit continuous composite acoustic data step 320 comprises holistic audio captured by the plurality of sensors of the acoustic sensor array 210. The transmit continuous composite acoustic data step 320 enables the composite signature processor 220 to receive real-time acoustic information for generating the composite signatures 222.

With continued reference to FIG. 3, a transmit current task/environmental context step 330 provides contextual information to the composite signature processor 220 for baseline comparison. During the transmit current task/environmental context step 330, the distributed anomaly detection system 200 transmits information regarding the current task being performed by the robotic system 10 and environmental conditions present during operation. The contextual information transmitted during the transmit current task/environmental context step 330 may include task profile identification, current operational mode, ambient temperature, and other environmental parameters. The transmit current task/environmental context step 330 enables the composite signature processor 220 to query the baseline signature database 250 for context-specific baseline signatures 232 that correspond to the current operational state of the robotic system 10. The contextual information provided during the transmit current task/environmental context step 330 enables comparison of the composite signatures 222 against baseline signatures 232 established under matching operational conditions, rather than comparison against a single global baseline.

The composite signature processor 220 performs a query context-specific baseline signatures step 340 to request relevant baseline signatures 232 from the baseline signature database 250. During the query context-specific baseline signatures step 340, the composite signature processor 220 transmits a query to the baseline signature database 250 that specifies the current operational context of the robotic system 10. The query transmitted during the query context-specific baseline signatures step 340 may include parameters identifying the current task profile, current joint configuration, current motion state, current load parameters, and current environmental conditions. The baseline signature database 250 receives the query and identifies stored baseline signatures 232 that correspond to the specified operational context parameters.

The query context-specific baseline signatures step 340 enables the retrieval of baseline signatures 232 that match the specific combination of operational parameters present during the current operation of the robotic system 10. Rather than comparing the composite signatures 222 against a single static baseline, the query context-specific baseline signatures step 340 retrieves baseline signatures 232 established under operational conditions matching the current operational state. This context-specific retrieval enables the detection of acoustic deviations that would be masked when comparing against a global baseline that does not account for variations in acoustic characteristics across different operational contexts.

The baseline signature database 250 performs a return baseline signatures step 350 in response to the query transmitted during the query context-specific baseline signatures step 340. During the return baseline signatures step 350, the baseline signature database 250 provides the baseline signatures 232 to the composite signature processor 220 for comparison against the composite signatures 222 generated from current acoustic measurements. The baseline signatures 232 returned during the return baseline signatures step 350 correspond to the operational context specified in the query, enabling comparison between current acoustic patterns and baseline acoustic patterns established under matching operational conditions.

The return baseline signatures step 350 may provide multiple baseline signatures 232 when the baseline signature database 250 stores multiple baseline records corresponding to the queried operational context. The multiple baseline signatures 232 may represent acoustic patterns captured during different operational cycles within the same operational context, enabling the anomaly detector 230 to compare current acoustic patterns with a range of baseline variations observed during nominal operation. The return baseline signatures step 350 may also provide statistical parameters characterizing expected variation ranges for the baseline signatures 232, enabling the anomaly detector 230 to distinguish deviations indicative of anomalous conditions from normal operational variation.

The comparison performed following the return baseline signatures step 350 enables the detection of deviations that would be missed by static threshold-based monitoring systems. Static threshold-based monitoring systems compare individual sensor readings against fixed threshold values without accounting for variations in expected acoustic characteristics associated with different operational contexts. A sensor reading that falls within acceptable ranges for one operational context may indicate an anomalous condition when observed during a different operational context. The context-specific comparison enabled by the query context-specific baseline signatures step 340, and the return baseline signatures step 350, accounts for these context-dependent variations in expected acoustic characteristics.

The baseline signatures 232 returned during the return baseline signatures step 350 may include acoustic characteristics specific to the current task profile being performed by the robotic system 10. Different task profiles may produce different acoustic emission patterns during nominal operation. A pick-and-place task may produce acoustic emissions with different frequency content, amplitude distributions, and temporal patterns compared to those of an assembly task or a welding task. The baseline signatures 232 for each task profile capture the acoustic characteristics associated with nominal performance for that task profile. Comparison of the composite signatures 222 against task-specific baseline signatures 232 enables detection of deviations from expected acoustic patterns for the specific task being performed.

The baseline signatures 232 returned during the return baseline signatures step 350 may include acoustic characteristics specific to the current configuration state of the robotic system 10. Different joint configurations may produce different acoustic propagation characteristics due to variations in mechanical coupling between segments of the robotic arm 100. The baseline signatures 232 corresponding to different configuration states capture the acoustic characteristics associated with each configuration. Comparison of the composite signatures 222 against configuration-specific baseline signatures 232 enables detection of deviations that account for expected acoustic variations associated with the current joint configuration.

The baseline signatures 232 returned during the return baseline signatures step 350 may include acoustic characteristics specific to current environmental conditions present during operation. Environmental conditions, including ambient temperature, external noise sources, and nearby equipment operation, may affect acoustic emissions and acoustic propagation within the robotic system 10. The baseline signatures 232, corresponding to different environmental conditions, capture the acoustic characteristics associated with nominal operation in each condition. Comparison of the composite signatures 222 against environment-specific baseline signatures 232 enables detection of deviations that account for expected acoustic variations associated with current environmental conditions.

The sequence diagram 300 includes a distributed anomaly detected frame 360 that encompasses the system response when anomalies are identified by the distributed anomaly detection system 200. The distributed anomaly detected frame 360 represents a conditional execution block that activates when the comparison between the composite signatures 222 and the baseline signatures 232 reveals deviations indicative of system degradation. The distributed anomaly detected frame 360 contains multiple steps that execute in response to the detection of anomalous acoustic patterns, enabling the distributed anomaly detection system 200 to generate both immediate operational responses and maintenance notifications.

Within the distributed anomaly detected frame 360, the adaptive behavior controller 240 performs a detect sub-threshold anomaly pattern step 362 to identify the sub-threshold anomaly pattern 234. During the detect sub-threshold anomaly pattern step 362, the adaptive behavior controller 240 analyzes the comparison results to determine whether individual sensors of the acoustic sensor array 210 remain below their respective alert thresholds while collective patterns across the plurality of sensors indicate degradation. The detect sub-threshold anomaly pattern step 362 evaluates whether the spatially distributed correlation across the acoustic sensor array 210 satisfies criteria for classification as a sub-threshold anomaly pattern 234. Individual sensors may each report readings at levels between 50% and 90% of their respective alert thresholds during the detect sub-threshold anomaly pattern step 362, yet the collective pattern of readings may indicate an anomalous system-level condition when analyzed as a composite signature. These percentages are examples and not meant to be limiting.

The detect sub-threshold anomaly pattern step 362 distinguishes between normal operational variation and anomalous patterns that warrant response. Normal operational variation may produce deviations from the baseline signatures 232 that fall within expected ranges established during baseline learning. The detect sub-threshold anomaly pattern step 362 compares observed deviations against expected variation ranges to determine whether the deviations exceed thresholds for classification as the sub-threshold anomaly pattern 234. When the detect sub-threshold anomaly pattern step 362 determines that observed deviations exceed expected variation ranges and exhibit spatially distributed correlation across multiple sensors, the adaptive behavior controller 240 classifies the condition as the sub-threshold anomaly pattern 234 and initiates response actions within the distributed anomaly detected frame 360.

Following detection of the sub-threshold anomaly pattern 234 during the detect sub-threshold anomaly pattern step 362, the distributed anomaly detection system 200 performs an adjust real-time motion parameters step 364 to implement the real-time motion parameter adjustment 244. During the adjust real-time motion parameters step 364, the adaptive behavior controller 240 generates the parameter adjustments 242 that modify operational parameters of the robotic system 10 in response to the detected sub-threshold anomaly pattern 234. The adjust real-time motion parameters step 364 implements modifications to velocity, acceleration, or trajectory parameters to mitigate the progression of the detected anomaly pattern. The real-time motion parameter adjustment 244 generated during the adjust real-time motion parameters step 364 is transmitted to the robot controller 12 for implementation during continued execution of the current task.

The adjust real-time motion parameters step 364 enables proactive modification of robotic operation before degradation progresses to levels that would trigger conventional threshold-based alerts. The parameter adjustments 242 generated during the adjust real-time motion parameters step 364 may reduce mechanical stress on components exhibiting acoustic signature deviations from the baseline signatures 232. By implementing the real-time motion parameter adjustment 244 in response to the sub-threshold anomaly pattern 234, the adjust real-time motion parameters step 364 may extend the operational life of affected components and reduce the likelihood of operational failures. The adjust real-time motion parameters step 364 may modify motion parameters while the robotic system 10 continues task execution, enabling continued operation with reduced stress on affected components rather than requiring immediate task interruption.

The distributed anomaly detected frame 360 includes a transmit predictive maintenance alert step 366 that generates the predictive maintenance alert 236 in response to detection of the sub-threshold anomaly pattern 234. During the transmit predictive maintenance alert step 366, the anomaly detector 230 generates the predictive maintenance alert 236 indicating that maintenance attention may be warranted based on the detected acoustic anomaly pattern. The transmit predictive maintenance alert step 366 transmits the predictive maintenance alert 236 to external systems through the maintenance alerts 34 of the system outputs 30. The predictive maintenance alert 236 generated during the transmit predictive maintenance alert step 366 indicates that maintenance may be warranted even though no individual sensor of the acoustic sensor array 210 has exceeded its respective alert threshold.

The transmit predictive maintenance alert step 366 may include information characterizing the detected sub-threshold anomaly pattern 234 within the predictive maintenance alert 236. The predictive maintenance alert 236 generated during the transmit predictive maintenance alert step 366 may identify specific locations or components within the robotic arm 100 exhibiting acoustic signature deviations. The transmit predictive maintenance alert step 366 may include severity indicators within the predictive maintenance alert 236 based on the magnitude of detected deviations from the baseline signatures 232. The predictive maintenance alert 236 may include an estimated time until maintenance intervention may be warranted, based on comparing current acoustic signatures with historical degradation patterns stored in the baseline signature database 250.

The adjust real-time motion parameters step 364, and the transmit predictive maintenance alert step 366 may execute in parallel within the distributed anomaly detected frame 360, enabling simultaneous operational response and maintenance notification. The parallel execution enables the distributed anomaly detection system 200 to implement immediate operational modifications via real-time motion parameter adjustment 244 while concurrently notifying maintenance systems via predictive maintenance alert 236. This parallel response enables both short-term mitigation through operational parameter adjustment and longer-term planning through maintenance scheduling based on the detected sub-threshold anomaly pattern 234.

The sequence diagram 300 includes a normal operation frame 370 that represents system behavior when the distributed anomaly detection system 200 detects no anomalies. The normal operation frame 370 represents a conditional execution block that activates when the comparison between the composite signatures 222 and the baseline signatures 232 does not reveal deviations indicative of system degradation. The normal operation frame 370 contains steps that execute when acoustic patterns captured by the acoustic sensor array 210 fall within expected variation ranges established during baseline learning, indicating that the robotic system 10 operates within nominal acoustic parameters for the current operational context.

Within the normal operation frame 370, the composite signature processor 220 performs a transmit normal status step 372 to indicate normal operating conditions to other components of the distributed anomaly detection system 200. During the transmit normal status step 372, the composite signature processor 220 generates a status indication confirming that the composite signatures 222 fall within acceptable deviation ranges from the baseline signatures 232 retrieved from the baseline signature database 250. The transmit normal status step 372 communicates that no sub-threshold anomaly pattern 234 has been detected and that the robotic system 10 exhibits acoustic characteristics consistent with nominal operation for the current task profile, configuration state, motion state, and environmental conditions.

The transmit normal status step 372 provides confirmation that the comparison between current acoustic patterns and context-specific baseline patterns has not identified deviations warranting operational response or maintenance notification. The status indication generated during the transmit normal status step 372 may be transmitted to the status report 238 for inclusion in the health reports 36 of the system outputs 30. The transmit normal status step 372 enables external monitoring systems and operator interfaces to receive confirmation that the distributed anomaly detection system 200 has analyzed current acoustic emissions and determined that the robotic system 10 operates within nominal parameters.

Following the transmit normal status step 372, the robot controller 12 performs a continue operation step 374 to maintain standard robotic operations. During the continue operation step 374, the robot controller 12 continues execution of the current task without modification to operational parameters. The continue operation step 374 represents continuation of normal task execution when the distributed anomaly detection system 200 has not detected acoustic anomalies warranting operational response. The continue operation step 374 enables the robotic system 10 to proceed with planned motion sequences, velocity profiles, and trajectory paths without intervention from the adaptive behavior controller 240.

The continue operation step 374 maintains the current operational state of the robotic system 10, while the distributed anomaly detection system 200 continues to monitor acoustic emissions from the acoustic sensor array 210. The continue operation step 374 does not modify the position/velocity data 122 transmitted from the robot controller 12 or alter control signals transmitted to the joint motors 14. The continue operation step 374 enables uninterrupted task execution when acoustic analysis confirms nominal operation, while the distributed anomaly detection system 200 maintains continuous monitoring capability to detect anomalies that may develop during subsequent operational cycles.

Following either the distributed anomaly detected frame 360 or the normal operation frame 370, the composite signature processor 220 performs an update baseline database step 380 to update the baseline signature database 250 with new acoustic signature data. During the update baseline database step 380, the composite signature processor 220 transmits the composite signatures 222 to the baseline signature database 250 for incorporation into stored baseline records. The update baseline database step 380 enables continuous adaptive learning by incorporating acoustic signature data from current operation into the baseline signature database 250 for use in future comparisons.

The update baseline database step 380 incorporates composite acoustic signatures classified as nominal for the corresponding operational context into the baseline signature database 250. When the comparison between the composite signatures 222 and the baseline signatures 232 indicates that current acoustic patterns fall within acceptable variation ranges, the update baseline database step 380 adds the current composite signatures 222 to the stored baseline records for the current operational context. The update baseline database step 380 enables the baseline signature database 250 to accumulate acoustic signature data from multiple operational cycles performed under matching operational conditions, refining the baseline signatures 232 over time as additional nominal operation data becomes available.

The update baseline database step 380 may update statistical parameters characterizing expected variation ranges for the baseline signatures 232. As the baseline signature database 250 accumulates additional composite signatures 222 classified as nominal for each operational context, the update baseline database step 380 may recalculate mean values, standard deviation values, and other statistical parameters that characterize expected acoustic characteristics for each context. The refined statistical parameters enable the anomaly detector 230 to distinguish between normal operational variation and anomalous patterns with improved accuracy as the baseline signature database 250 accumulates operational experience.

The update baseline database step 380 enables the distributed anomaly detection system 200 to adapt to gradual changes in acoustic characteristics of the robotic system 10 that occur during normal operation. Mechanical components may exhibit gradual changes in acoustic emission characteristics over extended operational periods, reflecting normal wear patterns and not indicating anomalous conditions. The update baseline database step 380 incorporates these gradual changes into the baseline signatures 232, enabling the anomaly detector 230 to distinguish between gradual nominal changes and anomalous deviations that warrant response. The continuous updates performed during the update baseline database step 380 maintain alignment between the baseline signatures 232 and the current acoustic characteristics of the robotic system 10 as the system accumulates operational cycles.

The update baseline database step 380 may selectively incorporate composite signatures 222 based on classification results from the anomaly detector 230. When the anomaly detector 230 classifies current acoustic patterns as nominal for the corresponding operational context, the update baseline database step 380 incorporates the composite signatures 222 into the baseline signature database 250. When the anomaly detector 230 detects the sub-threshold anomaly pattern 234, the update baseline database step 380 may exclude the corresponding composite signatures 222 from baseline updates to prevent the incorporation of anomalous acoustic patterns into the baseline signatures 232. This selective incorporation enables the baseline signature database 250 to maintain baseline signatures 232 that represent nominal acoustic characteristics rather than degraded acoustic characteristics.

The robot controller 12 performs an acknowledge status step 390 to confirm receipt of system status information from the distributed anomaly detection system 200. During the acknowledge status step 390, the robot controller 12 transmits an acknowledgment signal to the distributed anomaly detection system 200, confirming that status information has been received and processed. The acknowledge status step 390 completes the communication cycle between the distributed anomaly detection system 200 and the robot controller 12 for the current monitoring iteration.

The acknowledge status step 390 confirms that the robot controller 12 has received status information indicating either normal operation or detected anomalies from the distributed anomaly detection system 200. When the distributed anomaly detected frame 360 has executed, the acknowledge status step 390 confirms receipt of the real-time motion parameter adjustment 244 and any associated status information. When the normal operation frame 370 has executed, the acknowledge status step 390 confirms receipt of the normal status indication generated during the transmit normal status step 372. The acknowledge status step 390 enables the distributed anomaly detection system 200 to verify that status information has been successfully communicated to the robot controller 12.

Following the acknowledge status step 390, the sequence diagram 300 returns to the beginning of the monitoring loop, where the provide joint position/velocity data step 310 and the transmit continuous composite acoustic data step 320 continue providing data for the next monitoring iteration. The continuous monitoring loop illustrated by the sequence diagram 300 enables the distributed anomaly detection system 200 to maintain ongoing surveillance of acoustic emissions from the robotic system 10 throughout operation. Each iteration of the monitoring loop captures current acoustic emissions, compares composite signatures against context-specific baselines, responds to detected anomalies or confirms normal operation, updates the baseline signature database 250 with nominal acoustic data, and acknowledges status communication with the robot controller 12.

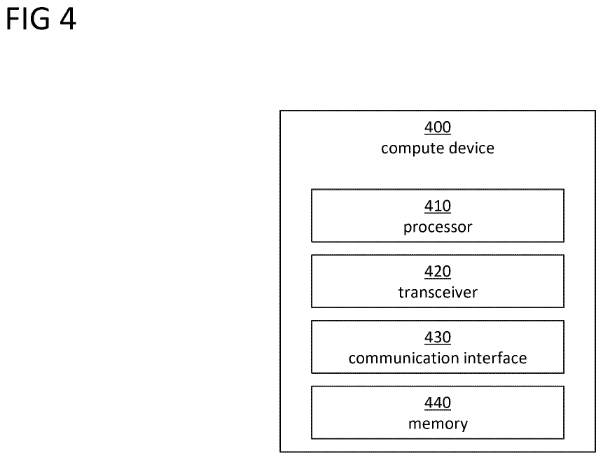

Referring to FIG. 4, a block diagram illustrates a compute device 400 that may implement the distributed anomaly detection system 200. The compute device 400 includes a processor 410, a transceiver 420, a communication interface 430, and a memory 440. The compute device 400 may be configured to perform the acoustic signature analysis, baseline comparison, and anomaly detection operations described with reference to the distributed anomaly detection system 200.

The processor 410 executes instructions to perform computational operations for the distributed anomaly detection system 200. The processor 410 may execute instructions to generate system-level composite acoustic signatures by combining temporally-synchronized acoustic responses from the plurality of sensors in the acoustic sensor array 210. The processor 410 may receive the composite acoustic data 212 from the acoustic sensor array 210 and process it to generate the composite signatures 222. The processor 410 may apply temporal synchronization to align acoustic measurements captured across the distributed sensor array to a common time reference, enabling correlation of acoustic events occurring at different spatial locations within the robotic system 10.

With continued reference to FIG. 4, the processor 410 may execute instructions to compare the system-level composite acoustic signatures against the context-specific baseline signatures 232 stored in the baseline signature database 250. The processor 410 may query the baseline signature database 250 for baseline signatures 232 corresponding to a current operational context of the robotic system 10. The processor 410 may compare the composite signatures 222 against the retrieved baseline signatures 232 to identify deviations indicative of anomalous conditions. The processor 410 may calculate the Acoustic Health Index based on frequency shifts, amplitude changes, and changes in wave velocity between the current and baseline acoustic characteristics.

The processor 410 may execute instructions to detect the sub-threshold anomaly pattern 234 by comparing the composite signatures 222 with the baseline signatures 232. Detection of the sub-threshold anomaly pattern 234 may be performed by the processor 410 independently of any individual sensor of the acoustic sensor array 210 exceeding its respective alert threshold. The processor 410 may analyze spatially distributed correlations across the plurality of sensors to identify anomalous system-level conditions undetectable from any individual sensor in isolation. The processor 410 may evaluate whether observed deviations exceed expected variation ranges and exhibit spatially distributed correlation across multiple sensors to determine whether classification as the sub-threshold anomaly pattern 234 is warranted.

As further shown in FIG. 4, the processor 410 may execute instructions to apply temperature compensation to the system-level composite acoustic signatures. The processor 410 may receive temperature measurements from temperature sensors embedded in manipulator segments and joints of the robotic arm 100. The processor 410 may apply the temperature-compensation formula to correct measured wave-velocity values for thermal effects on acoustic propagation properties. The temperature-compensated values may be used by the processor 410 when calculating the Acoustic Health Index and when comparing current acoustic characteristics against the baseline signatures 232.

The processor 410 may execute instructions to compensate for Doppler effects in the acoustic emissions based on the position/velocity data 122 received from the robot controller 12. The processor 410 may calculate expected Doppler shifts based on current joint velocities and sensor positions of the robotic system 10. The processor 410 may apply compensation factors to the composite acoustic data 212 to remove motion-induced frequency distortions from the composite signatures 222. The Doppler compensation performed by the processor 410 enables accurate acoustic signature analysis during dynamic robotic motion when segments of the robotic arm 100 move relative to sensors of the acoustic sensor array 210.

The processor 410 may execute instructions to generate the predictive maintenance alert 236 based on the sub-threshold anomaly pattern 234. When the processor 410 detects the sub-threshold anomaly pattern 234 by comparing the composite signatures 222 against the baseline signatures 232, the processor 410 may generate the predictive maintenance alert 236 indicating that maintenance attention may be warranted. The processor 410 may include information characterizing the detected sub-threshold anomaly pattern 234 within the predictive maintenance alert 236, including identification of specific locations or components exhibiting acoustic signature deviations and severity indicators based on magnitude of detected deviations.

The memory 440 stores data and instructions utilized by the processor 410 during operation of the distributed anomaly detection system 200. The memory 440 may store the baseline signature database 250, which contains the context-specific baseline signatures 232. The baseline signatures 232 stored in the memory 440 may correspond to distinct operational states of the robotic system 10, including different task profiles, configuration states, motion states, and environmental conditions. The memory 440 may store baseline signatures 232 for specific combinations of operational parameters, enabling the processor 410 to retrieve baseline signatures 232 corresponding to current operational conditions for comparison against the composite signatures 222.

With continued reference to FIG. 4, the memory 440 may store operational parameters used by the processor 410 during acoustic signature analysis and anomaly detection. The operational parameters stored in the memory 440 may include threshold values for classification of material fatigue risk based on the Acoustic Health Index, weighting factors for the frequency shift, amplitude change, and wave velocity change components of the Acoustic Health Index formula, and thermal correction coefficients for temperature compensation. The memory 440 may store reference temperature values and reference acoustic characteristics used by the processor 410 for baseline comparison operations.

The memory 440 may store historical degradation patterns accumulated over the operational time of the robotic system 10. Historical degradation patterns may comprise changes in acoustic signatures logged during previous operational cycles for trend analysis and predictive modeling. The processor 410 may access the historical degradation patterns stored in the memory 440 to compare current acoustic signature deviations against historical patterns of degradation progression. Comparing against historical degradation patterns may enable the processor 410 to estimate the remaining operational life before maintenance intervention may be warranted.

The memory 440 may store instructions that, when executed by the processor 410, cause the processor 410 to receive acoustic emissions data from the acoustic sensor array 210, generate the system-level composite acoustic signatures, compare the composite signatures against the context-specific baseline signatures 232, and detect the sub-threshold anomaly pattern 234. The instructions stored in the memory 440 may cause the processor 410 to generate the predictive maintenance alert 236 based on the sub-threshold anomaly pattern 234. The instructions stored in the memory 440 may cause the processor 410 to transmit a signal to the adaptive behavior controller 240 to proactively adjust operational parameters of the robotic system 10 to mitigate progression of the detected sub-threshold anomaly pattern 234.

The transceiver 420 enables wireless signal transmission and reception for the compute device 400. The transceiver 420 may enable the compute device 400 to communicate with external devices or systems through communication protocols. The transceiver 420 may transmit the predictive maintenance alert 236 to external monitoring systems or maintenance scheduling systems. The transceiver 420 may transmit the status report 238 to dashboard interfaces or data logging systems for operational visibility and historical tracking. The transceiver 420 may receive configuration data or operational parameters from external systems and store them in the memory 440.

The communication interface 430 provides data exchange connectivity between the compute device 400 and other components of the distributed anomaly detection system 200. The communication interface 430 may facilitate communication with the robot controller 12 to receive position/velocitydata 122 and transmit real-time motion parameter adjustment 244. The communication interface 430 may facilitate communication with the acoustic sensor array 210 to receive the composite acoustic data 212 captured during operation of the robotic system 10. The communication interface 430 may facilitate communication with the adaptive behavior controller 240 by transmitting signals indicating the detection of the sub-threshold anomaly pattern 234 and by coordinating the generation of the parameter adjustments 242.

As further shown in FIG. 4, the communication interface 430 may facilitate communication with external monitoring systems to transmit the system outputs 30, including the motion adjustments 32, the maintenance alerts 34, and the health reports 36. The communication interface 430 may support wired communication protocols for high-bandwidth data transfer between the compute device 400 and the acoustic sensor array 210. The communication interface 430 may support communication with multiple robotic systems when the compute device 400 provides distributed anomaly detection services for a plurality of robotic manipulators within a facility.

The compute device 400 may be implemented as a component of the distributed anomaly detection system 200 that performs acoustic signature processing, baseline comparison, and anomaly detection. The processor 410, the transceiver 420, the communication interface 430, and the memory 440 may be arranged within a device housing of the compute device 400. The compute device 400 may be positioned in proximity to the robotic system 10 to reduce communication latency between the acoustic sensor array 210 and the processor 410. In some implementations, the compute device 400 may be positioned remotely from the robotic system 10 and may communicate with the acoustic sensor array 210 and the robot controller 12 through the communication interface 430 or the transceiver 420.

The distributed anomaly detection system may include accelerometers configured as tri-axial sensors positioned at structural nodes of the mechanical system. The accelerometers may measure structural vibrations occurring during the operation of the mechanical system. The tri-axial configuration of the accelerometers enables measurement of vibration components along three orthogonal axes, providing comprehensive characterization of vibrational motion at each structural node where an accelerometer is positioned. The accelerometers may be positioned at locations where structural members connect or where vibrational energy concentrates during operation.

The accelerometers may distinguish operational motion from acoustic signals captured by the acoustic sensor array. During the operation of a robotic manipulator, structural vibrations may arise from multiple sources, including planned joint motion, motor operation, and acoustic wave propagation through structural members. The accelerometers may capture vibration data that enables separating vibration components attributable to planned operational motion from those attributable to acoustic phenomena. The vibration data from the accelerometers may be temporally correlated with the composite acoustic data to identify acoustic signal components corresponding to structural vibrations induced by operational motion. This correlation may enable the composite signature processor to isolate acoustic signature components that reflect structural health characteristics from those that reflect normal operational vibration.

The distributed anomaly detection system may include strain gauges bonded to high-stress areas of the mechanical system. The strain gauges may provide reference structural loading data during operation of the mechanical system. The strain gauges may be positioned at locations where structural members experience elevated stress levels during normal operation, such as near joints, at points of load application, or at geometric transitions. The strain gauges may measure local deformation at the bonded locations, providing quantitative data on the structural loading at each instrumented location.

The reference structural loading data from the strain gauges may be used to correlate acoustic signatures. The composite signature processor may correlate composite acoustic signatures with structural loading data measured by strain gauges to establish relationships between acoustic characteristics and loading conditions. The correlation between acoustic signatures and strain gauge measurements may enable validation of acoustic-based loading assessments against direct strain measurements. When composite acoustic signatures indicate loading conditions at a particular location, the strain gauge measurements at that location may serve as a reference to confirm or refine the acoustic-based assessment.

The accelerometers and strain gauges may provide supplementary validation data for the composite acoustic signature analysis performed by the distributed anomaly detection system. The validation data from the accelerometers and strain gauges may verify that the acoustic signature deviations detected by the anomaly detector correspond to actual structural conditions rather than measurement artifacts or environmental interference. The supplementary sensor data may be used during baseline establishment to correlate acoustic signatures with measured vibration characteristics and loading conditions. The supplementary sensor data may also be used during anomaly detection to validate that detected acoustic anomalies correspond to measurable changes in structural vibration or loading characteristics.

A number of implementations have been described. Nevertheless, it will be understood that various modifications may be made without departing from the spirit and scope of the disclosure. Accordingly, other implementations are within the scope of the claims.

The techniques described in this disclosure may also be illustrated in the following examples.

Example 1. A system, comprising: an acoustic sensor array configured to capture acoustic emissions from a mechanical system during operation of the mechanical system; a processor configured to: generate a system-level composite acoustic signature by combining temporally synchronized acoustic responses from a plurality of sensors of the acoustic sensor array; compare the system-level composite acoustic signature against context-specific baseline signatures; and detect a sub-threshold anomaly pattern based on the comparison, wherein detection of the sub-threshold anomaly pattern is performed independently of any individual sensor exceeding its respective alert threshold, and wherein the sub-threshold anomaly pattern represents a spatially distributed correlation across the plurality of sensors indicative of an anomalous system-level condition undetectable from any individual sensor in isolation.

Example 2. The system of example 1, further comprising an adaptive behavior controller configured to proactively adjust operational parameters of the mechanical system to mitigate progression of the detected sub-threshold anomaly pattern.

Example 3. The system of any one or more of examples 1-2, further comprising a baseline signature database configured to store the context-specific baseline signatures, wherein the context-specific baseline signatures correspond to distinct operational states of the mechanical system.

Example 4. The system of any one or more of examples 1-3, wherein the processor is further configured to generate a predictive maintenance alert based on the sub-threshold anomaly pattern.

Example 5. The system of any one or more of examples 3-4, wherein the processor is further configured to update the baseline signature database using composite acoustic signatures classified as nominal for a corresponding operational context.

Example 6. The system of any one or more of examples 1-5, wherein the operational parameters comprise at least one of velocity, acceleration, or trajectory.

Example 7. The system of any one or more of examples 1-6, wherein the distinct operational states comprise at least one of a task profile, a configuration state, a motion state, or an environmental condition.

Example 8. The system of any one or more of examples 1-7, wherein the system-level composite acoustic signature comprises frequency shift, amplitude change, or wave velocity change.

Example 9. The system of any one or more of examples 1-8, wherein the processor is further configured to apply temperature compensation to the system-level composite acoustic signature.

Example 10. The system of any one or more of examples 1-9, wherein the anomalous system-level condition comprises structural degradation, material fatigue, or stress concentration.

Example 11. A system, comprising: a robotic manipulator; a robot controller configured to control operation of the robotic manipulator and provide position data or velocity data associated with the robotic manipulator; an acoustic sensor array configured to capture acoustic emissions from the robotic manipulator during operation of the robotic manipulator; a processor configured to: generate a system-level composite acoustic signature by combining temporally synchronized acoustic responses from a plurality of sensors of the acoustic sensor array, wherein the system-level composite acoustic signature is synchronized with the position data or velocity data; compare the system-level composite acoustic signature against context-specific baseline signatures; and detect a sub-threshold anomaly pattern based on the comparison, wherein detection of the sub-threshold anomaly pattern is performed independently of any individual sensor exceeding its respective alert threshold, and wherein the sub-threshold anomaly pattern represents a spatially distributed correlation across the plurality of sensors indicative of an anomalous system-level condition undetectable from any individual sensor in isolation; and an adaptive behavior controller configured to adjust operational parameters of the robotic manipulator during continued execution of a task based on the sub-threshold anomaly pattern.

Example 12. The system of example 11, wherein the adaptive behavior controller is configured to proactively adjust the operational parameters to mitigate progression of the detected sub-threshold anomaly pattern.

Example 13. The system of any one or more of examples 11-12, further comprising a baseline signature database storing the context-specific baseline signatures, wherein the context-specific baseline signatures correspond to distinct operational states of the robotic manipulator.

Example 14. The system of any one or more of examples 11-13, wherein the processor is further configured to generate a predictive maintenance alert based on the sub-threshold anomaly pattern.

Example 15. The system of any one or more of examples 11-14, wherein the processor is further configured to update the baseline signature database using composite acoustic signatures classified as nominal for a corresponding operational context.

Example 16. The system of any one or more of examples 11-15, wherein the processor is further configured to compensate for Doppler effects in the acoustic emissions based on the position data or velocity data.

Example 17. The system of any one or more of examples 11-16, wherein the adaptive behavior controller is configured to redistribute load across joints of the robotic manipulator when the sub-threshold anomaly pattern indicates a localized anomaly.

Example 18. A non-transitory computer-readable medium storing instructions that, when executed by a processor, cause the processor to: receive acoustic emissions data from an acoustic sensor array capturing acoustic emissions from a mechanical system during operation of the mechanical system; generate a system-level composite acoustic signature by combining temporally synchronized acoustic responses from a plurality of sensors of the acoustic sensor array; compare the system-level composite acoustic signature against context-specific baseline signatures; and detect a sub-threshold anomaly pattern based on the comparison, wherein detection of the sub-threshold anomaly pattern is performed independently of any individual sensor exceeding its respective alert threshold, and wherein the sub-threshold anomaly pattern represents a spatially distributed correlation across the plurality of sensors indicative of an anomalous system-level condition undetectable from any individual sensor in isolation.

Example 19. The non-transitory computer-readable medium of example 18, wherein the instructions further cause the processor to generate a predictive maintenance alert based on the sub-threshold anomaly pattern.

Example 20. The non-transitory computer-readable medium of any one or more of examples 18-19, wherein the instructions further cause the processor to transmit a signal to an adaptive behavior controller to proactively adjust operational parameters of the mechanical system to mitigate progression of the detected sub-threshold anomaly pattern.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A system, comprising:
an acoustic sensor array configured to capture acoustic emissions from a mechanical system during operation of the mechanical system;
a processor configured to:
generate a system-level composite acoustic signature by combining temporally synchronized acoustic responses from a plurality of sensors of the acoustic sensor array;
compare the system-level composite acoustic signature against context-specific baseline signatures; and
detect a sub-threshold anomaly pattern based on the comparison, wherein detection of the sub-threshold anomaly pattern is performed independently of any individual sensor exceeding its respective alert threshold, and wherein the sub-threshold anomaly pattern represents a spatially distributed correlation across the plurality of sensors indicative of an anomalous system-level condition undetectable from any individual sensor in isolation.

2. The system of claim 1, further comprising an adaptive behavior controller configured to proactively adjust operational parameters of the mechanical system to mitigate progression of the detected sub-threshold anomaly pattern.

3. The system of claim 1, further comprising a baseline signature database configured to store the context-specific baseline signatures, wherein the context-specific baseline signatures correspond to distinct operational states of the mechanical system.

4. The system of claim 1, wherein the processor is further configured to generate a predictive maintenance alert based on the sub-threshold anomaly pattern.

5. The system of claim 3, wherein the processor is further configured to update the baseline signature database using composite acoustic signatures classified as nominal for a corresponding operational context.

6. The system of claim 2, wherein the operational parameters comprise at least one of velocity, acceleration, or trajectory.

7. The system of claim 3, wherein the distinct operational states comprise at least one of a task profile, a configuration state, a motion state, or an environmental condition.

8. The system of claim 1, wherein the system-level composite acoustic signature comprises frequency shift, amplitude change, or wave velocity change.

9. The system of claim 1, wherein the processor is further configured to apply temperature compensation to the system-level composite acoustic signature.

10. The system of claim 1, wherein the anomalous system-level condition comprises structural degradation, material fatigue, or stress concentration.

11. A system, comprising:
a robotic manipulator;
a robot controller configured to control operation of the robotic manipulator and provide position data or velocity data associated with the robotic manipulator;
an acoustic sensor array configured to capture acoustic emissions from the robotic manipulator during operation of the robotic manipulator;
a processor configured to:
generate a system-level composite acoustic signature by combining temporally synchronized acoustic responses from a plurality of sensors of the acoustic sensor array, wherein the system-level composite acoustic signature is synchronized with the position data or velocity data;
compare the system-level composite acoustic signature against context-specific baseline signatures; and
detect a sub-threshold anomaly pattern based on the comparison, wherein detection of the sub-threshold anomaly pattern is performed independently of any individual sensor exceeding its respective alert threshold, and wherein the sub-threshold anomaly pattern represents a spatially distributed correlation across the plurality of sensors indicative of an anomalous system-level condition undetectable from any individual sensor in isolation; and
an adaptive behavior controller configured to adjust operational parameters of the robotic manipulator during continued execution of a task based on the sub-threshold anomaly pattern.

12. The system of claim 11, wherein the adaptive behavior controller is configured to proactively adjust the operational parameters to mitigate progression of the detected sub-threshold anomaly pattern.

13. The system of claim 11, further comprising a baseline signature database storing the context-specific baseline signatures, wherein the context-specific baseline signatures correspond to distinct operational states of the robotic manipulator.

14. The system of claim 11, wherein the processor is further configured to generate a predictive maintenance alert based on the sub-threshold anomaly pattern.

15. The system of claim 13, wherein the processor is further configured to update the baseline signature database using composite acoustic signatures classified as nominal for a corresponding operational context.

16. The system of claim 11, wherein the processor is further configured to compensate for Doppler effects in the acoustic emissions based on the position data or velocity data.

17. The system of claim 11, wherein the adaptive behavior controller is configured to redistribute load across joints of the robotic manipulator when the sub-threshold anomaly pattern indicates a localized anomaly.

18. A non-transitory computer-readable medium storing instructions that, when executed by a processor, cause the processor to:
receive acoustic emissions data from an acoustic sensor array capturing acoustic emissions from a mechanical system during operation of the mechanical system;
generate a system-level composite acoustic signature by combining temporally synchronized acoustic responses from a plurality of sensors of the acoustic sensor array;
compare the system-level composite acoustic signature against context-specific baseline signatures; and
detect a sub-threshold anomaly pattern based on the comparison, wherein detection of the sub-threshold anomaly pattern is performed independently of any individual sensor exceeding its respective alert threshold, and wherein the sub-threshold anomaly pattern represents a spatially distributed correlation across the plurality of sensors indicative of an anomalous system-level condition undetectable from any individual sensor in isolation.

19. The non-transitory computer-readable medium of claim 18, wherein the instructions further cause the processor to generate a predictive maintenance alert based on the sub-threshold anomaly pattern.

20. The non-transitory computer-readable medium of claim 18, wherein the instructions further cause the processor to transmit a signal to an adaptive behavior controller to proactively adjust operational parameters of the mechanical system to mitigate progression of the detected sub-threshold anomaly pattern.
